(19) United States
(12) Patent Application Publication
(10) Pub. No.: US 2007/0014885 A1
(43) Pub. Date: Jan. 18, 2007

(54) Blank carrying/filling apparatus

(75) Inventor: Fa-Shen Chen, Taichung City (TW)

Correspondence Address: TROXELL LAW OFFICE PLLC, SUITE 1404, 5205 LEESBURG PIKE, FALLS CHURCH, VA, 22041, US

(73) Assignee: KING STEEL MACHINERY CO., LTD.

(21) Appl. No.: 11/181,736

(22) Filed: Jul. 15, 2005

(51) Int. Cl. A01J 21/00

(52) U.S. Cl. 425/406

(57) ABSTRACT

A blank carrying/filling apparatus including: a bed member having a body section, at least one tunnel with a predetermined diameter extending through the body section from a back face to a front face thereof; at least one blank carrying section for carrying a blank; a thrust body having at least one thrust member slidable disposed in the tunnel and movable between a blank carrying position and a blank releasing position, whereby when the thrust member is positioned in the blank releasing position, the thrust member via physical action force disconnects the blank carrying section and the blank carried by the blank carrying section and releases the blank; and a driving member for forcing the thrust member to move between the blank carrying position and the blank releasing position.

### BACKGROUND OF THE INVENTION

The present invention is related to a polymer molding machine, and more particularly to a blank carrying/filling apparatus.

In conventional molding technique, a pre-made blank is first placed in a mold and then molded. This can shorten the molding time. In general, when the blank is placed into the mold, the mold has been heated to a certain temperature. Therefore, the time for filling the blank into the mold is quite limited. That is, an operator must respectively fill many blanks into the mold cavity in short time. This is inconvenient. In order to prolong the time for filling the blanks into the mold, the mold must be at the normal temperature or only slightly heated. However, this will delay the manufacturing procedure and reduce manufacturing efficiency.

### SUMMARY OF THE INVENTION

It is therefore a primary object of the present invention to provide a blank carrying/filling apparatus by which the contact time between the blanks and the mold in an open state can be shortened.

It is a further object of the present invention to provide the above blank carrying/filling apparatus by which multiple blanks can be synchronously respectively filled into the mold cavity in short time.

According to the above objects, the blank carrying/filling apparatus of the present invention includes: a bed member having a body section, at least one tunnel with a predetermined diameter extending through the body section from a back face to a front face thereof; at least one blank carrying section for carrying a blank; a thrust body having at least one thrust member slidable disposed in the tunnel and movable between a blank carrying position and a blank releasing position, whereby when the thrust member is positioned in the blank releasing position, the thrust member via physical action force disconnects the blank carrying section and the blank carried by the blank carrying section and releases the blank; and a driving member for forcing the thrust member to move between the blank carrying position and the blank releasing position.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 is a front view of the first embodiment of the present invention;

FIG. 4 is a top view of the first embodiment of the present invention, showing that the thrust members are positioned in the blank carrying position;

FIG. 5 is a top view of the first embodiment of the present invention, showing that the thrust members are released;

FIG. 6 is a top view of the first embodiment of the present invention, showing that the thrust members are positioned in the blank releasing position;

FIG. 7 is a perspective assembled view of a second embodiment of the present invention;

FIG. 8 is a perspective exploded view of the second embodiment of the present invention;

FIG. 9 is a side view of the second embodiment of the present invention, showing that the thrust members are positioned in the blank carrying position;

FIG. 10 is a top view according to FIG. 9;

FIG. 11 is a side view of the second embodiment of the present invention, showing that the thrust members are positioned in the blank releasing position;

FIG. 12 is a top view according to FIG. 11;

FIG. 13 is a perspective assembled view of a third embodiment of the present invention;

FIG. 14 is a perspective exploded view of the third embodiment of the present invention;

FIG. 15 is a side view of the third embodiment of the present invention, showing that the thrust members are positioned in the blank carrying position;

FIG. 16 is a side view of the third embodiment of the present invention, showing that the thrust members are positioned in the blank releasing position;

FIG. 17 is a sectional view of a fourth embodiment of the present invention, showing that the thrust members are positioned in the blank carrying position;

FIG. 18 is a side view of the fourth embodiment of the present invention, showing that the thrust members are positioned in the blank releasing position;

FIG. 19 is a side view of the fourth embodiment of the present invention and a cooperative opening/closing drive unit, in which the blank carrying/filling apparatus is positioned in an upper position for placing the blanks onto the blank carrying/filling apparatus; and

FIG. 20 is a side view of the fourth embodiment of the present invention and the cooperative opening/closing drive unit, in which the blank carrying/filling apparatus is positioned in a lower position for filling the blanks into the mold cavity.

### DETAILED DESCRIPTION OF THE PREFERRED EMBODIMENTS

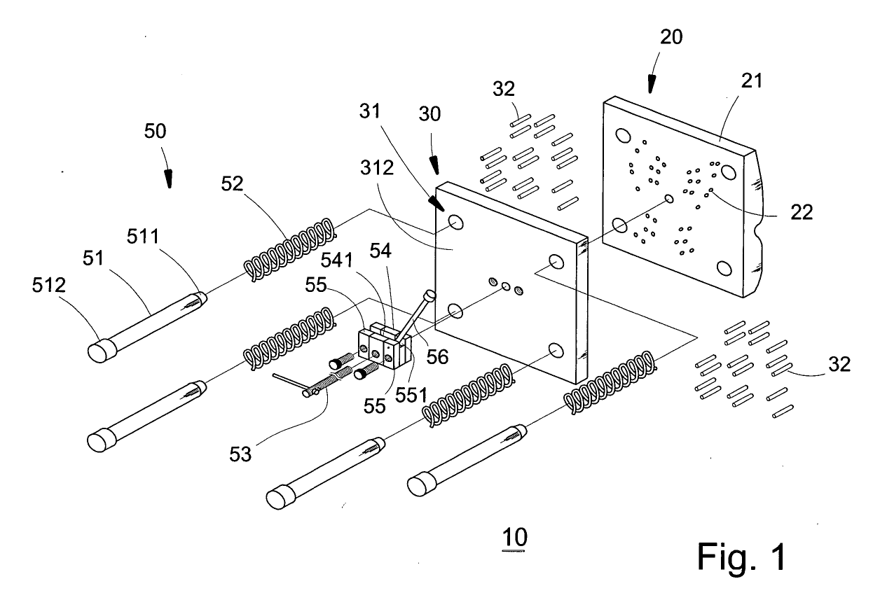

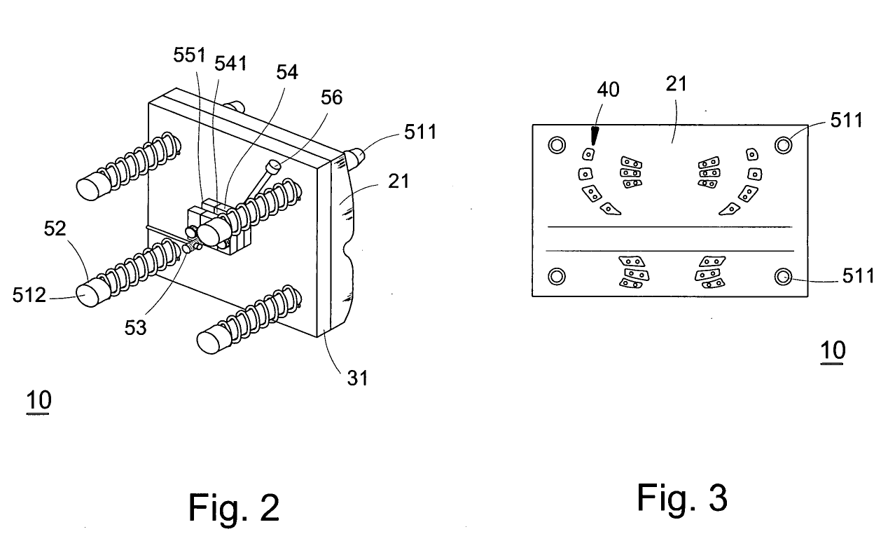

Please refer to FIGS. 1 to 6. According to a first embodiment, the blank carrying/filling apparatus 10 of the present invention includes a bed member 20, a thrust body 30, multiple blank carrying sections 40 and a driving member 50.

The bed member 20 has a substantially rectangular board-like body section 21 with a certain thickness. Several straight tunnels 22 extend through the body section 21 from a back face to a front face thereof. Each tunnel 22 has a certain diameter.

The thrust body 30 has board-like thrust section 31 with a shape similar to that of the body section 21. The thrust section 31 has a front face 311 facing the body section 21 and a back face 312 distal from the body section 21. The front face 311 of the thrust section 31 parallelly correspondingly attaches to the back face of the body section 21. The thrust section 31 has several pin-like thrust members 32. First ends of the thrust members 32 are fixedly connected with the front face 311 of the thrust section 31 and coaxially fitted through the corresponding tunnels 22. The thrust members 32 are reciprocally axially movable between a blank carrying position and a blank releasing position. The thrust member 32 has a length larger than the thickness of the body section 21.

The blank carrying sections 40 are recesses with different shapes and depths. The recesses 40 are formed on the front face of the body section 21 respectively corresponding to the tunnels 22. In other words, the open ends of the tunnels 22 formed on the front face of the body section 21 are respectively positioned on the bottom walls of the blank carrying sections 40.

The driving member 50 has four shaft rods 51 respectively passing through four corners of the thrust section 31. First ends 511 of the shaft rods 51 are tapered and fixedly connected with four corners of the body section 21. The first ends 511 protrude from the front face of the body section 21 by a certain length. A second end of each shaft rod 51 is formed with an annular shoulder section 512. Four springs 52 are respectively fitted on the shaft rods 51. Two ends of the spring 52 respectively abut against the back face 312 of the thrust section 31 and the shoulder section 512 of the shaft rod 51. The springs 52 serve to resiliently force the thrust section 31 to axially move toward and attach to the body section 21. One end of a driving threaded rod 53 is rotatably connected with the body section 21. A middle section of the threaded rod 53 axially movably extends through the thrust section 31. A threaded collar 54 is screwed on the threaded rod 53. One end of the threaded collar 54 abuts against the back face 312 of the thrust section 31. Two lateral stopper bodies 55 are fixedly disposed on the back face 312 of the thrust section 31 on two sides of the threaded rod 53. The stopper bodies 55 respectively abut against two sides of the threaded collar 54 so as to restrict the threaded collar 54 from rotating along with the threaded rod 53. However, the stopper bodies 55 permit the threaded collar 54 to move along the axis of the threaded rod 53. One end of a rod-like movable linking member 56 is pivotally connected one of the stopper bodies 55. The linking member 56 is pivotally rotatable between an engaged position and a disengaged position. When in the engaged position, the linking member 56 is engaged in engaging grooves 551, 541 respectively formed on the stopper bodies and the threaded collar. Under such circumstance, the threaded collar 54 is fixed with the linking member 56 and the stopper bodies 55 and thus fixed with the thrust section 31.

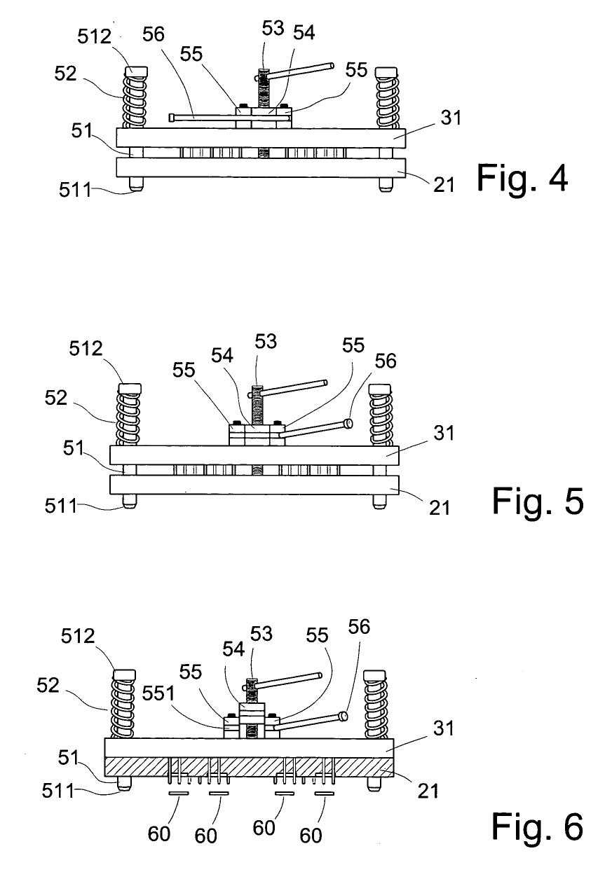

According to the above arrangement, in blank carrying and filling operation of the blank carrying/filling apparatus 10, the linking member 56 is first positioned in the engaged position, whereby the threaded collar 54 is fixedly with the stopper bodies 55 and the thrust section 31. Then the threaded rod 53 is pivoted to enlarge the distance between the thrust section 31 and the body section 21, whereby second ends of the thrust members 32 are sunk into the tunnels 22 of the body section 21 and positioned in the blank carrying position as shown in FIG. 4. At this time, the external blanks 60 can be placed into the corresponding blank carrying sections 40.

Thereafter, the blank carrying/filling apparatus 10 is moved to upper side of the mold cavity of the mold. The tapered ends 511 of the shaft rods 51 are coaxially inserted into the insertion holes formed on the mold so as to locate the blank carrying/filling apparatus 10 above the mold cavity. In other words, at this time, the blanks carried by the blank carrying/filling apparatus 10 are respectively positioned above the corresponding positions of the mold cavity. Then, the linking member 56 is rotated to the disengaged position as shown in FIG. 5. At this time, the springs 52 resiliently push the thrust section 31 to move along the axis of the shaft rods 51 until the front face 511 abuts against the body section 21. The thrust members 52 synchronously axially move within the tunnels 22 and the second ends of the thrust members 52 extend through the tunnels 22 and protrude from the blank carrying sections 40 out of the body section 21. At this time, the thrust members 52 are positioned in the blank releasing position as shown in FIG. 6. At the same time, the second ends of the thrust members 52 push out the blanks 60 inlaid in the corresponding blank carrying sections 40. The blanks 60 drop down into the corresponding positions of the mold cavity. Accordingly, in one single mold filling procedure, multiple different blanks can be simultaneously filled into the mold. Therefore, the time for filling the mold is greatly shortened and the manufacturing efficiency is enhanced.

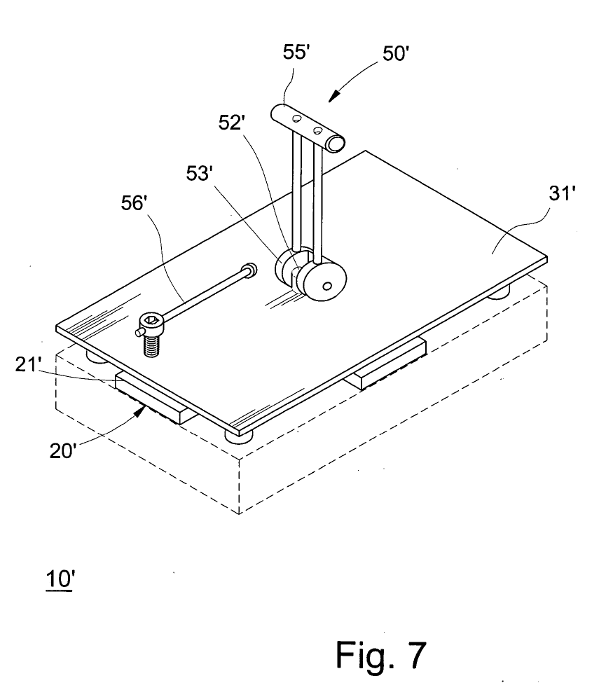

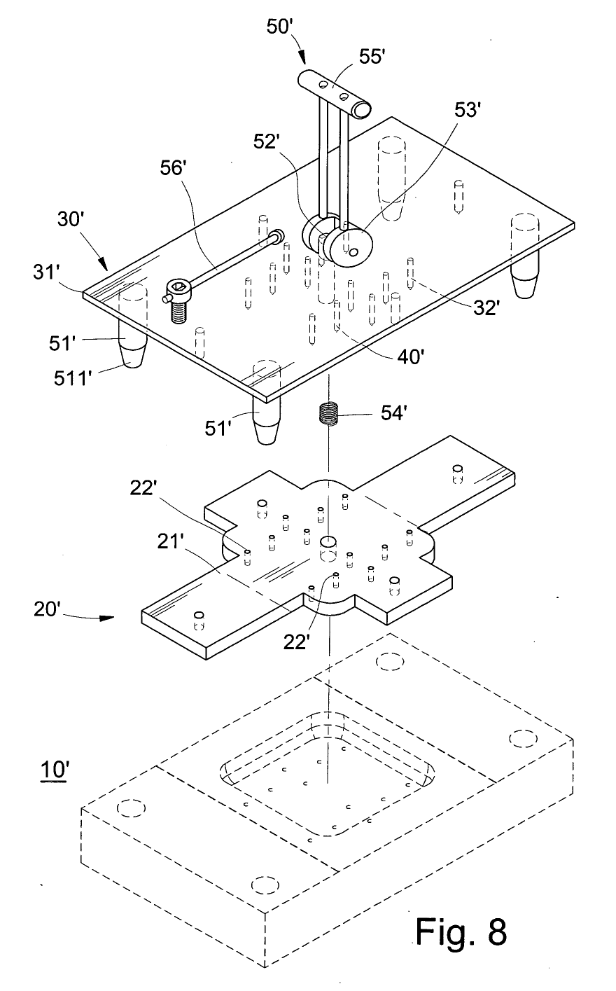

FIGS. 7 to 12 show a second embodiment of the blank carrying/filling apparatus 10′ of the present invention. The blank carrying/filling apparatus 10′ includes a bed member 20′, a thrust body 30′, multiple blank carrying sections 40′ and a driving member 50′.

The bed member 20′ has a board-like body section 21′ with a certain thickness. Several tunnels 22′ extend through the body section 21′ from a back face to a front face thereof.

The thrust body 30′ has board-like thrust section 31′. The thrust section 31 has a front face facing the body section 21′ and a back face distal from the body section 21′. The thrust section 31′ is positioned in parallel to the body section 21′. The thrust section 31′ has several pin-like thrust members 32′. First ends of the thrust members 32′ are fixedly connected with the front face of the thrust section 31′ and coaxially fitted through the corresponding tunnels 22′. The thrust members 32′ are axially movable within the tunnels 22′ between a blank carrying position and a blank releasing position. The thrust member 32′ has a length larger than the thickness of the body section 21′.

The blank carrying sections 40′ are respectively formed at the second ends of the thrust members 32′. Substantially, the second ends of the thrust members 32′ are sharpened to serve as the blank carrying sections 40′.

The driving member 50′ has four first shaft rods 51′. First ends of the first shaft rods 51′ are fixedly connected with the thrust section 31′. Second ends 511′ of the first shaft rods 51′ extend over the body section 21′ and protrude from the front face of the body sect ion 21′. The second ends 511′ are tapered. One end of a second shaft rod 52′ is fixedly connected with the body section 21′. The other end of the second shaft rod 52′ extends through the thrust section 31′ and protrudes from the back face of the thrust section 31′. The axis of the second shaft rod 52′ is parallel to the axis of the first shaft rod 51′. A circular eccentric rotary member 53′ is eccentrically perpendicularly pivotally connected with the other end of the second shaft rod 52′. A spring 54′ is fitted on the second shaft rod 52′ between the body section 21′ and the thrust section 31′. The spring 54′ serves to resiliently forcedly keep the body section 21′ and the thrust section 31′ spaced from each other. A shift bar 55′ is fixedly connected with the rotary member 53′. An external force can be applied to the shift bar 55′ to rotate the rotary member 53′. A movable restricting member 56′ is pivotally connected with the thrust section 31 for restricting the shift bar 55′ from rotating and thus locating the rotary member 53′.

The second embodiment of the blank carrying/filling apparatus 10′ of the present invention is mainly different from the first embodiment in that the blank releasing position and blank carrying position of the thrust members 32′ of the second embodiment are reverse to those of the first embodiment.

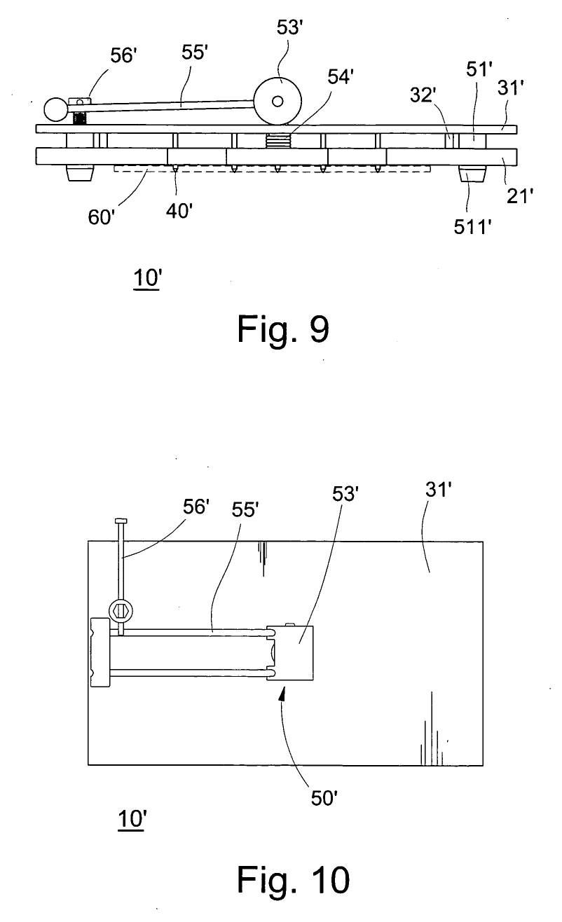

To speak more specifically, the eccentric rotary member 53′ can be first rotated via the shift bar 55′. At this time, the spring 54′ is compressed and the distance between the thrust section 31′ and the body section 21′ is shortened. Accordingly, the second ends of the thrust members 32′ respectively extend through the corresponding tunnels 22′ and protrude from the body section 21′. At this time, the thrust members 32′ are positioned in the blank carrying position. The external blanks 60′ can be respectively thrust by the blank carrying sections 40′ and previously located in true positions as shown in FIGS. 9 and 10.

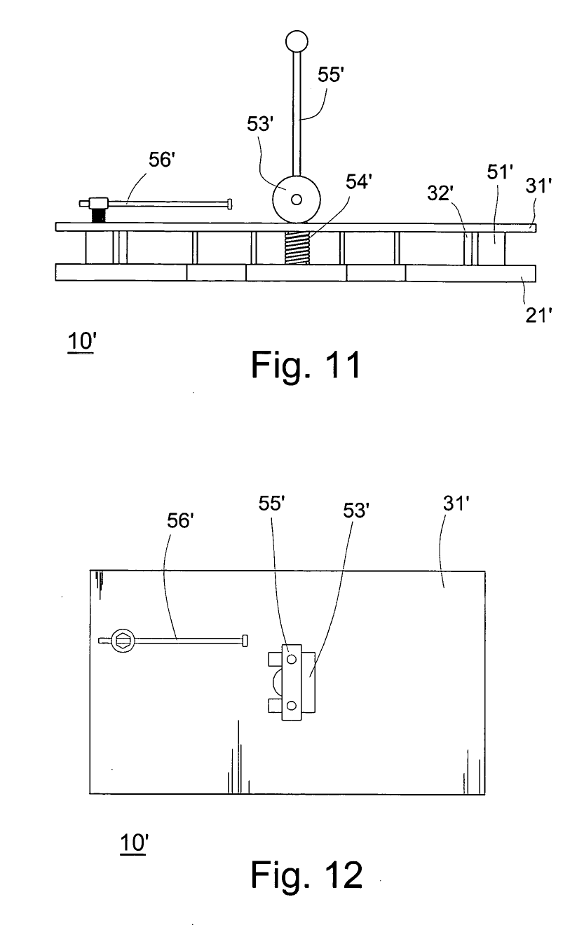

Then, the restricting member 56′ is rotated to release the shift bar 55′. At this time, the spring 54′ resiliently pushes the thrust section 31′ to enlarge the distance between the thrust section 31′ and the body section 21′. Accordingly, the second ends of the thrust members 32′ are sunk into the corresponding tunnels 22′ and positioned in the blank releasing position. Under such circumstance, the blanks 60′ originally thrust by the blank carrying sections 40′ are disconnected therefrom and drop down as shown in FIGS. 11 and 12.

Therefore, the second embodiment of the blank carrying/filling apparatus 10′ of the present invention can achieve the same effect as the first embodiment.

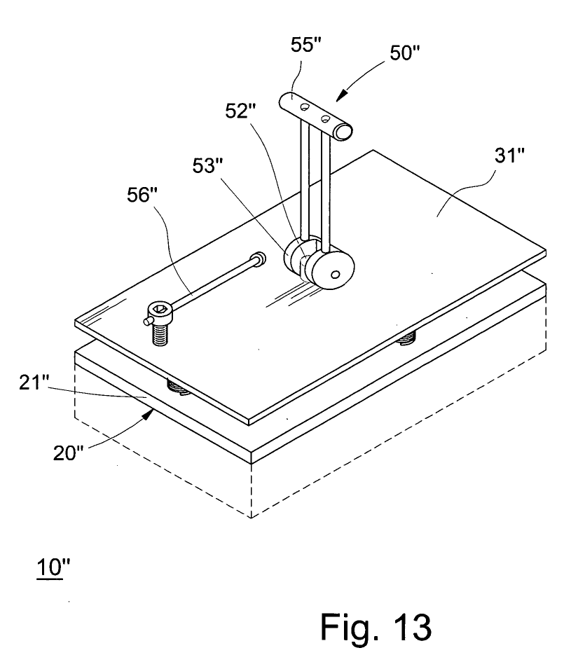

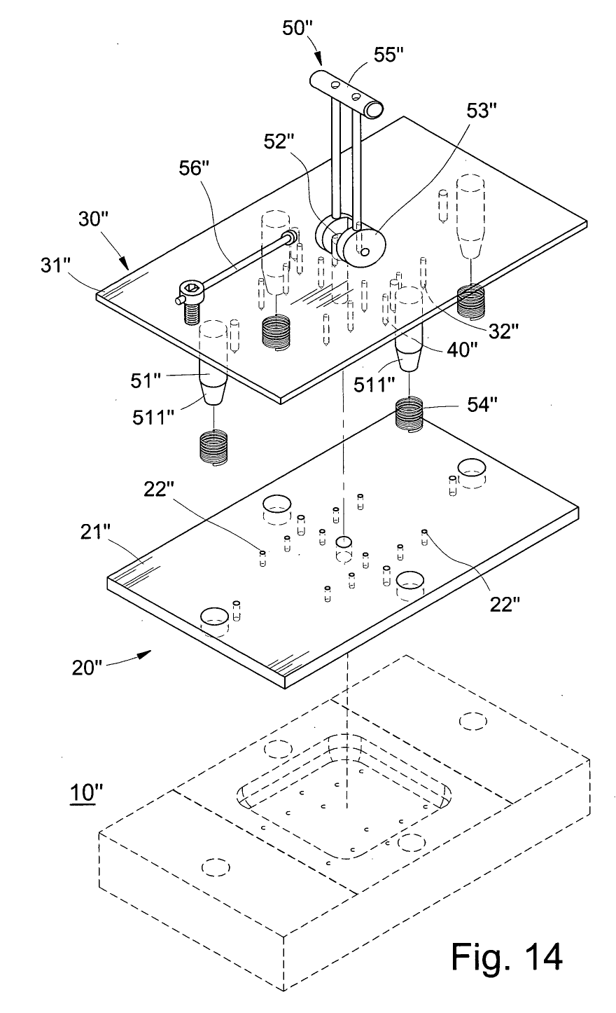

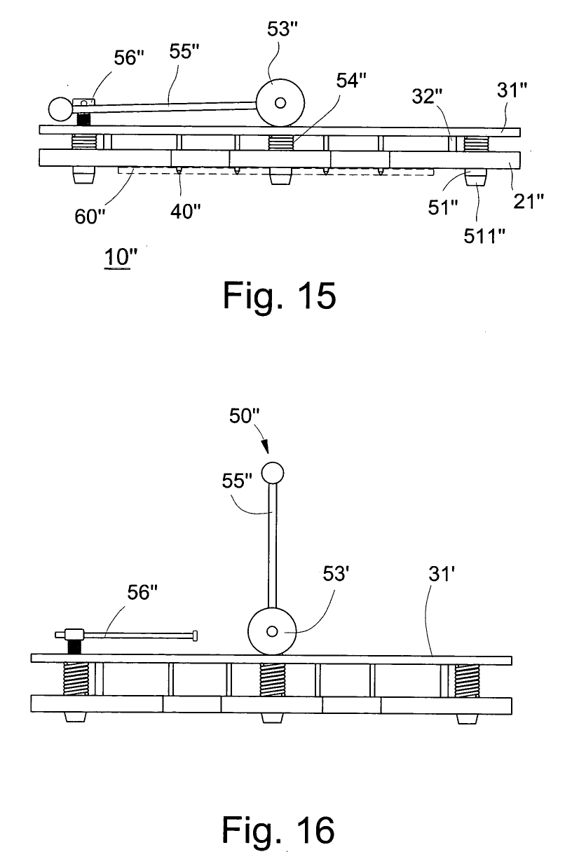

FIGS. 13 to 16 show a third embodiment of the blank carrying/filling apparatus 10″ of the present invention. The blank carrying/filling apparatus 10″ is substantially identical to the second embodiment. There are two differences between the third and second embodiments. First, there are four springs 54″ in the third embodiment. The four springs 54″ are respectively fitted on the first shaft rods 51″. Second, the first shaft rods 51″ extend through four through holes of the body section 21″ to locate and space the thrust section 31″ from the body section 21″. However, the third embodiment can achieve the same effect as the second embodiment.

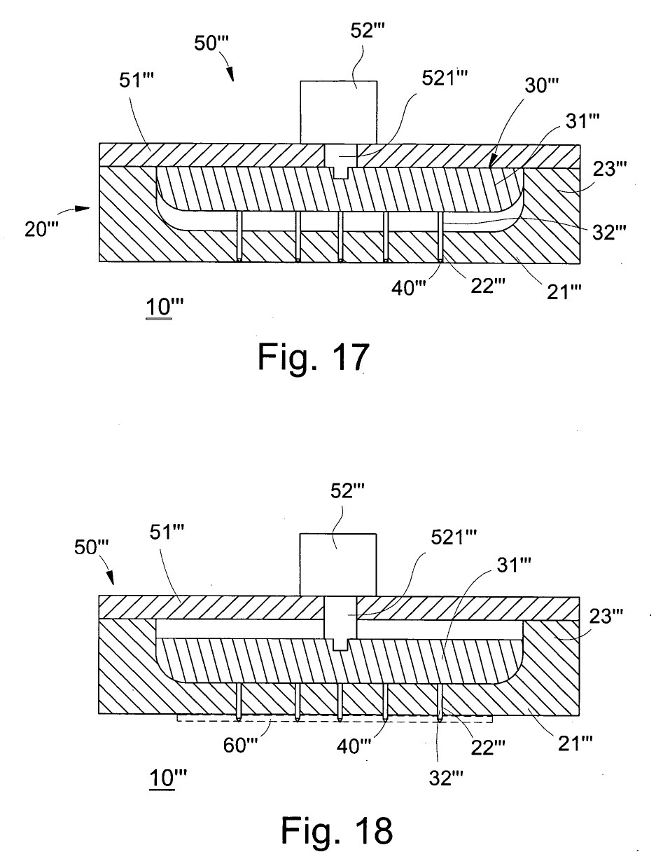

FIGS. 17 to 20 show a fourth embodiment of the blank carrying/filling apparatus 10′″ of the present invention. The blank carrying/filling apparatus 10′″ is substantially identical to the second embodiment. The difference between the fourth and the second embodiment is that the bed member 20′″ is further formed with an annular wall 23′″ around the body section 21′″ in addition to the tunnels 22′″.

The thrust body 30′″ has a thrust section 31′″ in parallel to the body section 21′″. The thrust section 31′″ is slidably fitted in the body section 21′″ and enclosed by the annular wall 23′″.

The driving member 50′″ is different from that of the second embodiment. The driving member 50′″ has a board-like seat body 51′″ bridged over the annular wall 23′″ and spaced from the body section 21′″. The thrust section 31′″ is movable between the seat body 51′″ and the body section 21′″. A hydraulic cylinder 52′″ is fixedly disposed on the seat body 51′″. An output shaft 521′″ of the hydraulic cylinder 52′″ is perpendicularly fixedly connected with the thrust section 31′″ for pushing the thrust section 31′″ to move. Accordingly, the thrust members 32′″ can be driven to move between the blank carrying position and blank releasing position.

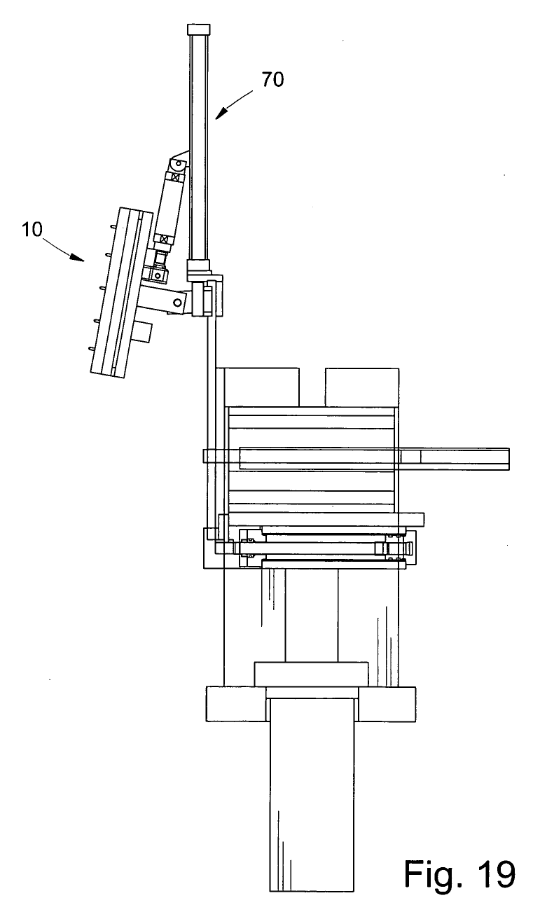

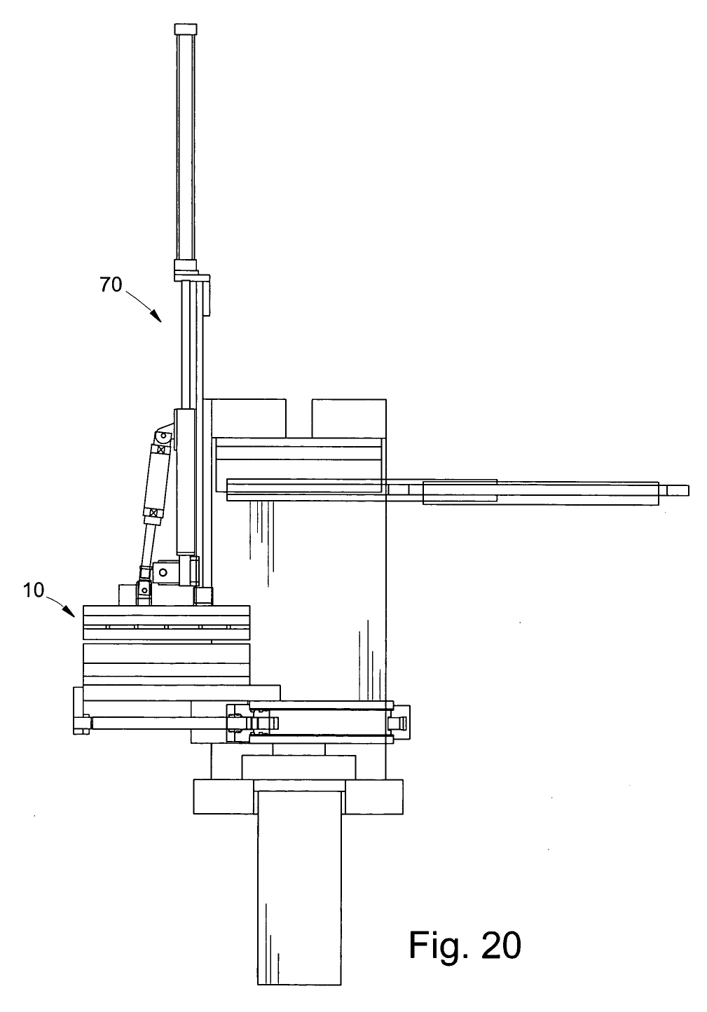

The fourth embodiment is applicable to automated blank carrying/filling operation. Referring to FIGS. 19 and 20, the blank carrying/filling apparatus 10′ cooperates with a conventional opening/closing drive unit 70′ in carrying/filling the blanks. When carrying the blanks 60′, the blank carrying/filling apparatus 10′″ is driven and laterally turned by the drive unit 70′″ to one side. At this time, the blanks can be humanly placed on the blank carrying/filling apparatus 10′″ as shown in FIG. 19. When filling the blanks into the mold, as shown in FIG. 20, the blank carrying/filling apparatus 10′″ is driven by the drive unit 70′″ to a horizontal position above the mold cavity. Accordingly, the blank carrying/filling apparatus 10′″ can be semi-automatically operated to speed the manufacturing procedure.

The above embodiments are only used to illustrate the present invention, not intended to limit the scope thereof. Many modifications of the above embodiments can be made without departing from the spirit of the present invention.

What is claimed is:

1. A blank carrying/filling apparatus comprising:
a bed member having a body section, at least one tunnel with a predetermined diameter extending through the body section from a back face to a front face thereof;
at least one blank carrying section for carrying a blank;
a thrust body having at least one thrust member slidable disposed in the tunnel and movable between a blank carrying position and a blank releasing position, whereby when the thrust member is positioned in the blank releasing position, the thrust member via physical action force disconnects the blank carrying section and the blank carried by the blank carrying section and releases the blank; and
a driving member for forcing the thrust member to move between the blank carrying position and the blank releasing position.

2. The blank carrying/filling apparatus as claimed in claim 1, wherein the thrust members are pin-like and coaxially slidably fitted through the tunnels, the second ends of the thrust members being sharpened to serve as the blank carrying sections for thrusting and carrying the blanks.

3. The blank carrying/filling apparatus as claimed in claim 2, wherein when the thrust members are positioned in the blank carrying position, the second ends of the thrust members respectively extend through the tunnels and protrude from the openings of the tunnels on the front face of body section, while when the thrust members are positioned in the blank releasing position, the second ends of the thrust members retract into the tunnel.

4. The blank carrying/filling apparatus as claimed in claim 1, wherein the blank carrying sections are formed on the front face of the body section corresponding to the openings of the tunnels.

5. The blank carrying/filling apparatus as claimed in claim 4, wherein the blank carrying sections are recesses with a predetermined depth.

6. The blank carrying/filling apparatus as claimed in claim 4, wherein when the thrust members are positioned in the blank releasing position, the second ends of the thrust members respectively extend through the tunnels and protrude from the openings of the tunnels on the front face of body section, while when the thrust members are positioned in the blank carrying position, the second ends of the thrust members retract into the tunnel.

7. The blank carrying/filling apparatus as claimed in claim 1, wherein the thrust body further includes a thrust section parallel to the back face of the body section, the driving member serving to provide power for moving the thrust section and the body section relative to each other.

8. The blank carrying/filling apparatus as claimed in claim 7, wherein the driving member has a seat body parallelly arranged on the back face of the body section, the thrust section being movably disposed between the seat body and the body section, a hydraulic cylinder being fixedly disposed on the seat body,.an output shaft of the hydraulic cylinder being connected with the thrust section.

9. The blank carrying/filling apparatus as claimed in claim 7, wherein the driving member further includes at least one shaft rod bridged between the body section and the thrust section and at least one spring fitted on the shaft rod.

10. The blank carrying/filling apparatus as claimed in claim 9, wherein one end of the shaft rod is tapered.

11. The blank carrying/filling apparatus as claimed in claim 9, wherein the spring is positioned between the body section and the thrust section.

12. The blank carrying/filling apparatus as claimed in claim 11, wherein the driving member further includes an eccentric rotary member pivotally connected with the shaft rod via a pivot shaft to abut against the back face of the thrust section, an axis of the shaft rod being perpendicular to an axis of the pivot shaft.

13. The blank carrying/filling apparatus as claimed in claim 9, wherein the spring is fitted on the shaft rod between the body section and the thrust section.

14. The blank carrying/filling apparatus as claimed in claim 13, wherein the driving member further includes a driving threaded rod, one end of the threaded rod being rotatably connected with the body section, the other end of the threaded rod passing through the thrust section and outward extending, a threaded collar being screwed on the threaded rod, one end of the threaded collar abutting against the back face of the thrust section, at least one lateral stopper bodies being fixedly disposed on the back face of the thrust section on one side of the threaded rod, the stopper body abutting against the side of the threaded collar so as to restrict the threaded collar from rotating along with the threaded rod, a movable linking member being pivotally connected with the stopper body for engaging the stopper body with the threaded collar, whereby the threaded collar is fixed with the linking member and the stopper body and thus fixed with the thrust section.
